(19) United States
(12) Patent Application Publication
(10) Pub. No.: US 2023/0314567 A1
(43) Pub. Date: Oct. 5, 2023

(54) SYSTEM FOR IDENTIFYING BLACK ICE AND WATER ON ROADS

(71) Applicant: TriEye Ltd., Tel Aviv (IL)

(72) Inventors: Elior Dekel, Tel Aviv (IL); Ariel Danan, Tel Aviv (IL); Omer Kapach, Tel Aviv (IL); Avraham Bakal, Tel Aviv (IL); Uriel Levy, Tel Aviv (IL)

(21) Appl. No.: 17/912,622

(22) PCT Filed: Apr. 10, 2021
(86) PCT No.: PCT/IB2021/052985

§ 371 Date: Sep. 19, 2022

Related U.S. Application Data
(60) Provisional application No. 63/010,091, filed on Apr. 15, 2020.

(51) Int. Cl. G01S 7/48; G01S 7/499; G01S 17/931

(52) U.S. Cl. CPC G01S 7/4802; G01S 7/499; G01S 17/931

(57) ABSTRACT

Systems and methods for detection of hazardous media on roads. A system may comprise a imaging receiver operating in the short wave infrared range (SWIR) and including a focal plane array (FPA) and a polarization filter array (PFA) comprising micro-polarizers, and an analysis module for analyzing SWIR image data obtained under passive or active illuminations conditions for detection of hazardous media on a road, wherein the hazardous media includes ice. In some embodiments, the FPA comprises germanium-on-silicon photodetectors (PDs). In some embodiments, the micro-polarizers are integrated with the PDs.

### CROSS REFERENCE TO RELATED APPLICATIONS

This is a 371 application from international patent application PCT/IB2021/052985 filed Apr. 10, 2021, which claims the benefit of U.S. Provisional patent application No. 63/010,091 filed Apr. 15, 2020, which is incorporated herein by reference in its entirety.

### FIELD

Embodiments disclosed herein relate in general to vision systems for automotive applications and in particular to vision systems for detecting hazardous materials on roads.

### BACKGROUND

The injury and death toll for automotive accidents is extremely high. Hazardous driving conditions are a main cause of auto accidents.

Water on the road reduces traction, and enough of it, or at certain speeds, can cause a vehicle to skid. Even a very thin sheet of ice can cause the wheels to slip with no friction along the road.

For drivers, perhaps the most dangerous aspect of ice on the road is that in some cases it can be nearly invisible. This situation is known as “black ice” and is characterized by a thin, very transparent sheet of ice. The black asphalt of the road can be seen through the ice and this is what gives black ice its name.

The dangers of black ice, though deadly for human drivers, whose vision is limited to the visible spectrum, is also true for standard CMOS-based camera for which the spectrum of detection is limited to below ˜1 micron (μm) wavelength. Like human eyes, such conventional vision systems which are based in the visible (VIS) or in the near infrared (NIR) spectrum are unable to detect black ice.

FIG. 1A shows known ice and water absorption spectra. There are clear differences in the spectra of water and ice in the short wave infrared (SWIR) regime (or “range”), i.e. at wavelengths in the range of 1-1.7 μm. Thus, black ice can be detected by imaging systems operating in the SWIR regime. Another main advantage of using a SWIR spectrum is that optical power used for active illumination with some known systems can be orders of magnitude higher than with conventional automotive visions systems operating in the VIS and the NIR, because at SWIR wavelengths the light is much safer for the human eye.

In known art, the intensity of light reflected from diffused surfaces (such as roads) is expected to be unpolarized. However, when light is specularly reflected (especially obliquely) through a flat interface between two media of different refractive indices, such as air and ice or water, it becomes highly polarized. Furthermore, when light propagates through ice crystals having some birefringence, polarization can be rotated. The sensitivity of polarization to ice on the road has been observed, e.g. in “Optical Detection of Dangerous Road Conditions”, Sensors 2019, 19, 1360; doi:10.3390/s19061360.

At present, there are no simple, known CMOS compatible focal plane arrays (FPAs) with polarization filter arrays (“PFAs”, also referred to as arrays of micro-polarizers) operating in the SWIR regime for the purpose of detecting hazardous media (for example black ice, water and motor oil) on roads.

### SUMMARY

Embodiments disclosed herein teach a system and method that use a CMOS compatible FPA operating in the SWIR regime and a polarization filter array (PFA) to detect hazardous media on roads. In some embodiments, the detection is passive. In some embodiments, the detection uses active illumination.

In exemplary embodiments, there are provided systems comprising a camera operating in the SWIR range and including a FPA and a PFA, the camera operative to acquire SWIR image data, and an analysis module for analyzing the SWIR image data for detection of hazardous media on a road, wherein the hazardous media includes ice.

In some embodiments, the FPA may include germanium-on-silicon (Ge-on-Si or Ge—Si) photodetectors (PDs). The PFA may include an arrangement of micro-polarizers. Each Ge—Si PD or some PDs may be associated with a respective micro-polarizer. The associated micro-polarizer may be integrated with the PD.

In some embodiments, a system may further comprise a first illumination source for illuminating a target scene in a first SWIR range, and the SWIR image data may include data carried by radiation reflected in the first SWIR range, for example at 1.26 μm.

In some embodiments, a system may further comprise a second illumination source for illuminating a target scene in a second SWIR range, and the SWIR image data may include data carried by radiation reflected in the second SWIR range, for example at 1.4 μm.

### BRIEF DESCRIPTION OF THE DRAWINGS

Aspects, embodiments and features disclosed herein will become apparent from the following detailed description when considered in conjunction with the accompanying drawings. In the drawings and descriptions set forth, identical reference numerals indicate those components that are common to different embodiments or configurations:

FIG. 1A shows graphs of ice and water absorption spectra as function of wavelength;

FIGS. 1B, 1C and 1D are schematic block diagrams illustrating active SWIR imaging systems;

FIG. 1E is an exemplary graph illustrating relative magnitudes of noise power after different durations of integration times in a SWIR imaging system;

FIG. 2 is a schematic block diagram illustrating another active SWIR imaging system disclosed herein;

FIG. 3A shows various types of color filter arrays and polarization filter arrays;

FIG. 3B shows an example of the structure of a single photo-detecting (PD) element with an integrated micro-polarizer in a Ge-on-Si FPA disclosed herein;

FIG. 4 shows schematically an embodiment of a passive imaging system for detection of hazardous media on roads disclosed herein;

FIG. 5 shows schematically an embodiment of an active imaging system for detection of hazardous media on roads;

FIGS. 6A, 6B and 6C show respectively a flowchart and schematic drawings of a method of operation of an active SWIR imaging system according to some embodiments;

FIGS. 7A, 7B and 7C show respectively a flowchart and schematic drawings of an exemplary method of operation of an active SWIR imaging system;

FIG. 8 is a flowchart illustrating a method for generating SWIR images of objects in a FOV of an EO system.

### DETAILED DESCRIPTION

The SWIR spectral band is ideal for ice and water detection because of their prominent absorption peak near the wavelength of 1450 nm. This spectral feature is red-shifted (moved to longer wavelengths) in ice with respect to water by ˜50 nm. Light reflected from the road and arriving at the SWIR FPA after propagating through a layer of ice will have a different spectral signature when compared to light that has propagated through a layer of water. By comparing the intensity of light at two wavelengths around the absorption peak, these differences can be identified and the water and ice and be identified.

The spectral information can be obtained either by employing a color filter array (CFA) overlaid upon the focal plane array, by using active illumination (either broadband in the SWIR, or in each of a range of wavelengths), or by combination of both passive and active illumination. Possible wavelength ranges are in the 1-1.55 μm SWIR range, for example at 1.26 μm and 1.4 μm. Another possible range is 1.1-1.4 μm.

The proposed active illumination can be realized with passive or active Q-switched lasers, for example, a laser operating at 1370 nm. Other examples include lamps or super luminescent diodes operating in the 1300-1500 nm band.

The high intensity available for the proposed active illumination enables a strong signal at the SWIR sensor. This serves to overcome any noisy scenarios, either internal to the system, or external. External noise can occur e.g. from adverse weather conditions.

The high definition spatial resolution (with pixel count of quarter VGA and above) of the proposed SWIR sensor is crucial in order to maintain a resolution necessary for detection of road hazards at a distance and spatially segmenting them, even after the demosaicing of the proposed filter array.

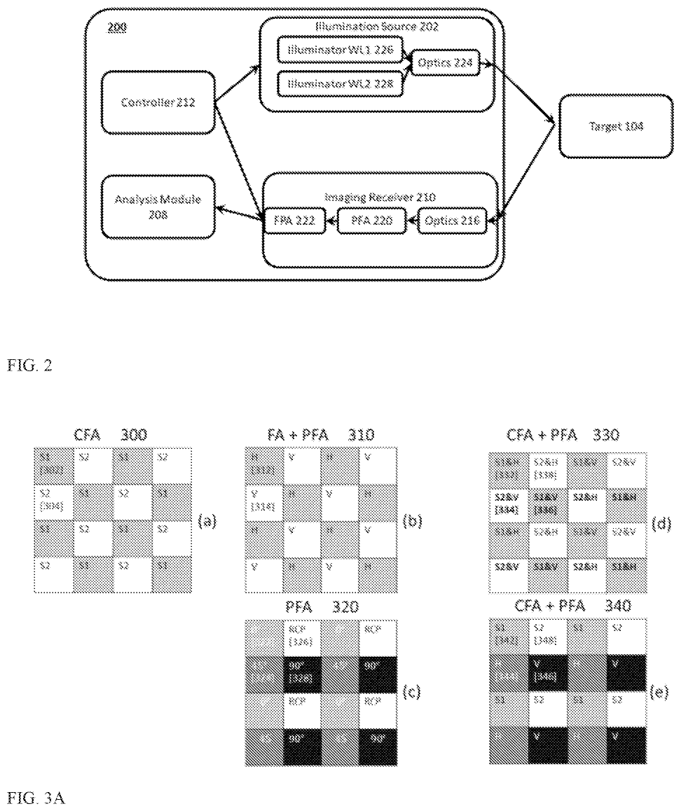

In some embodiments, the SWIR sensor is based on a CMOS compatible Ge—Si pixel architecture. This enables the required photosensitivity in the SWIR around the ice and water absorption peaks. The polarization filter (shown schematically in FIG. 3) is integrated

The SWIR FPA allows detection, classification and localization of ice and water on the road, alerting the driver and preparing the vehicle for the oncoming change in driving conditions, for example altering the braking function and suspension to anti-slip mode.

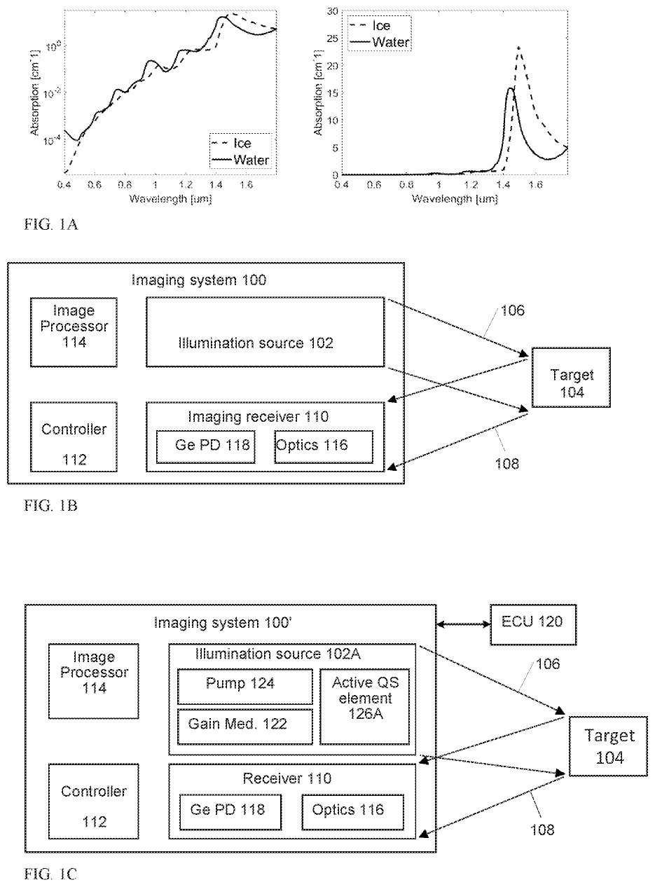

FIGS. 1B-1D are schematic block diagrams illustrating respectively active SWIR imaging systems numbered respectively 100, 100′ and 100″. As used herein, an “active” imaging system is operative to detect light reaching the system from its field-of-view (FOV), detect it by an imaging receiver (e.g. camera, LIDAR, or any other suitable type of sensor) that includes a plurality of PDs, and process the detection signals to provide one or more images of the field of view or part thereof. The term “image” refers to a digital representation of a scene detected by the imaging system, which stores a color value for each picture element (pixel) in the image, each pixel color representing light arriving to the imaging system from a different part of the field-of-view (e.g., a 0.02° by 0.02° part of the FOV, depending on receiver optics). It is noted that optionally, the imaging system may be further operative to generate other representations of objects or light in the FOV (e.g., a depths map, 3D model, polygon mesh), but the term “image” refers to two-dimensional (2D) image with no depth data.

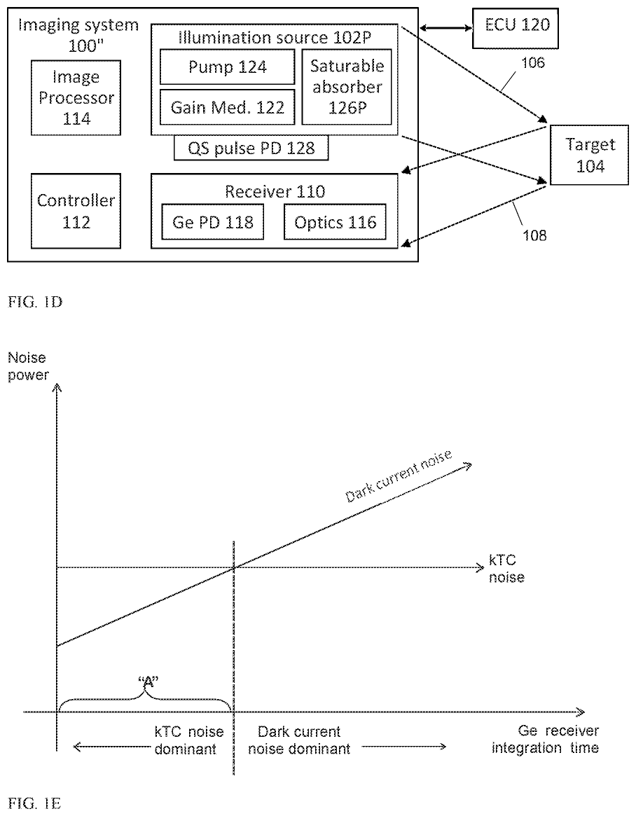

In FIG. 1B, system 100 comprises at least one illumination source (IS) 102 operative to emit radiation pulses in the SWIR band towards one or more targets 104, resulting in reflected radiation from the target reflected back in the direction of system 100. In FIG. 1B, outgoing illumination is denoted 106 and illumination reflected toward system 100 is denoted 108. Parts of the emitted radiation may also be reflected in other directions, deflected, or absorbed by the target. The term “target” refers to any object in the FOV of the imaging sensor, such as solids, liquid, flexible, and rigid objects. Some non-limiting examples of such objects include vehicles, roads, people, animals, plants, buildings, electronics, clouds, microscopic samples, items during manufacturing, and so on. Any suitable type of illumination source 102 may be used, such as one or more lasers, one or more light emitting diodes (LEDs), one or more incidence flashlights, any combination of the above, and so on (such individual light emitting elements are also referred to as “illuminators”). As discussed below in greater detail, illumination source 102 may optionally include one or more active lasers, or one or more passively Q-switched laser (“P-QS”) lasers. Further and as described with reference to FIG. 2 below, illumination source 102 may include optics for illuminating a field of view and including the target, and the illuminators may emit at different wavelengths.

System 100 also includes at least one imaging receiver (or simply “receiver”) 110 that includes a plurality of germanium (Ge) photodetectors (PDs) operative to detect the reflected SWIR radiation. In some embodiments, the imaging receiver may include a SWIR focal plane array (not shown) see description of FIG. 2. The Ge PDs may be part of or form the SWIR FPA. The receiver produces for each of the plurality of Ge PDs an electrical signal that is representative of the amount of impinging SWIR light within its detectable spectral range. That amount includes the amount of reflected SWIR radiation pulse light from the target, and may also include additional SWIR light (e.g., arriving from the sun or from external light sources).

The term “Ge PD” pertains to any PD in which light induced excitation of electrons (later detectable as a photocurrent) occurs within the Ge, within a Ge alloy (e.g., SiGe), or at the interface between Ge (or Ge alloy) and another material (e.g., silicon, SiGe). Specifically, the term “Ge PD” pertains both to pure Ge PDs and to Ge-silicon PDs. When Ge PDs which include both Ge and silicon are used, different concentration of geranium may be used. For example, the relative portion of Ge in the Ge PDs (whether alloyed with silicon or adjacent to it) may range from 5% to 99%. For example, the relative portion of Ge in the Ge PDs may be between 15% and 40%. It is noted that materials other than silicon may also be part of the Ge PD, such as aluminum, nickel, silicide, or any other suitable material. In some implementation of the disclosure, the Ge PDs may be pure Ge PDs (including more than 99.0% Ge).

It is noted that the receiver may be implemented as a PDA manufactured on a single chip. Any of the PD arrays discussed throughout the present disclosure may be used as receiver 110. The Ge PDs may be arranged in any suitable arrangement, such as a rectangular matrix (straight rows and straight columns of Ge PD), honeycomb tiling, and even irregular configurations. Preferably, the number of Ge PDs in the receiver allows generation of high-resolution image. For example, the number of PDs may be in the order of scale of 1 Megapixel, 10 Megapixel, or more.

In some embodiments, receiver 110 has any combination of the following specifications:
a. HFOV (horizontal field of view): between 1 m-10 m, 10 m-50 m, 50 m-100 m, 100 m-500 m, or more than 500 m.
b. WD (working distance): between 1 m-10 m, 10 m-50 m, 50 m-100 m, 100 m 500 m, or more than 500 m.
c. Pixel Size: between 1 μm-2 μm, 2 μm-4 μm, 4 μm-7 μm, 7 μm-12 μm, 10 μm 20 μm, or larger.
d. Resolution (on Obj.): between 1 mm-10 mm, 10 mm-50 mm, 50 mm-100 mm, 100 mm-500 mm, or more than 500 mm.
e. Pixels #[H or V]: between 100 and 500, between 1,000 and 2,000, between 2,000 and 10,000, or more than 10,000.
f. Aspect Ratio: 4:3, 3:2, 3:1, 16:9, 5:3, 5:4, 1:1, any ratio between 1:1 and 1:100.
g. View Angle [H or V]: between 1°-5°, 5°-15°, 10°-30°, 25°-50°, 50°-150°, or more.
h. Collection (the ratio of collected photons to emitted photons assuming target reflectivity of 100% and assuming Lambertian reflectance): between 1-10 e⁻⁷, 1-10 e⁻⁸. 1-10 e⁻⁹. 1-10 e⁻¹⁰.

For example, an example receiver may have the following parameters: HFOV of 60 m, WD of 150 m, pixel size of 10 μm, object resolution of 58 mm, pixel resolution of 1,050H by 1,112V, aspect ratio of 3:1, view angle of 0.4 radian, and collection ratio of about 3 e⁻⁹.

It is noted that targets of different reflectivity may be detectable by receiver 110, such as target reflectivity of 1%, 5%, 10%, 20%, and so on.

In addition to the impinging SWIR light as discussed above, the electrical signal produced by each of the Ge PDs is also representative of:
a. Readout noise, which is random, and its magnitude is independent (or substantially independent) on the integration time. Example of such noise includes Nyquist Johnson noise (also referred to as thermal noise or kTC noise). The readout process may also introduce a DC component to the signal, in addition to the statistical component, but the term “readout noise” pertains to the random component of the signal introduced by the readout process.
b. Dark current noise, which is random and accumulating over the integration time (i.e., it is integration-time dependent). The dark current also introduces in addition to the statistical component a DC component to the signal (which may or may not be eliminated, e.g., as discussed with respect to FIGS. 12A through 22), but the term “dark current noise” pertains to the random component of the signal accumulated over the integration time resulting from the dark current.

Some Ge PDs, and especially some PDs that combine Ge with another material (such as silicon, for example) are characterized by a relatively high level of dark current. For example, the dark current of Ge PDs may be larger than 50 μA/cm² (pertaining to a surface area of the PD) and even larger (e.g., larger than 100 μA/cm², larger than 200 μA/cm², or larger than 500 μA/cm²). Depending on the surface area of the PD, such levels of dark current may be translated to 50 picoampere (pA) per Ge PD or more (e.g., more than 100 pA per Ge PD, more than 200 pA per Ge PD, more than 500 pA per Ge PD, or more than 2 nA per Ge PD). It is noted that different sizes of PDs may be used, such as about 10 mm², about 50 mm², about 100 mm², about 500 mm²). It is noted that different magnitudes of dark current may be generated by the Ge PDs when the Ge PDs are subject to different levels of nonzero bias (which induce on each of the plurality of Ge PDs a dark current that is, for example, larger than 50 picoampere).

System 100 further comprises a controller 112, which controls operation of receiver 110 (and optionally also of illumination source 102 and/or other components) and an image processor 114. Controller 112 is therefore configured to control activation of receiver 110 for a relatively short integration time, such that to limit the effect of accumulation of dark current noise on the quality of the signal. For example, controller 112 may be operative to control activation of receiver 110 for an integration time during which the accumulated dark current noise does not exceed the integration-time independent readout noise.

Refer now to FIG. 1E, which is an exemplary graph illustrating relative magnitudes of noise power after different durations of integration times, in accordance with examples of the presently disclosed subject matter. For a given laser pulse energy, the signal to noise ratio (SNR) is mostly dictated by the noise level that includes the dark current noise (noise of the dark photocurrent) and thermal noise (also referred to as kTC noise). As shown in the exemplary graph of FIG. 1E, either of the dark current noise or the thermal noise are dominant in effecting the SNR of the electric signal of the PD, depending on the integration time of Ge-based receiver 110. Since controller 112 limits the activation time of the Ge photodetector for a relatively short time (within the range designated as “A” in FIG. 1E), not many electrons originating from dark current noise are collected and the SNR is therefore improved and is thus affected mainly by the thermal noise. For a longer receiver integration time, the noise originating from the dark current of the Ge photodetector becomes dominant over the thermal noise in affecting the receiver SNR, resulting in degraded receiver performance. It is noted that the graph of FIG. 1E is merely illustrative, and that accumulation of dark current noise over time is usually increasing with the square root of the time Eₙₒᵢₛₑ∞\sqrt{T_{integration}}·(alternatively, consider the y-axis as drawn on a matching non-linear polynomial scale). Also, the axes do not cross each other at zero integration time (in which case the accumulated dark current noise is zero).

Reverting to system 100, it is noted that controller 112 may control activation of receiver 110 for even shorter integration times (e.g., integration times during which the accumulated dark current noise does not exceed half of the readout noise, or a quarter of the readout noise). It is noted that unless specifically desired, limiting the integration time to very low levels limits the amount of light induced signals which may be detected, and worsens the SNR with respect to the thermal noise. It is noted that the level of thermal noise in readout circuitries suitable for reading of noisy signals (which require collection of relatively high signal level) introduces nonnegligible readout noise, which may significantly deteriorate the SNR.

In some implementations, somewhat longer integration times may be applied by controller 112 (e.g., integration times during which the accumulated dark current noise does not exceed twice the readout noise, or ×1.5 of the readout noise).

Exemplary embodiments disclosed herein relate to systems and methods for high SNR active SWIR imaging using receivers including Ge based PDs. The major advantage of Ge receiver technology vs. InGaAs technology is the compatibility with CMOS processes, allowing manufacture of the receiver as part of a CMOS production line. For example, Ge PDs can be integrated into CMOS processes by growing Ge epilayers on a silicon (Si) substrate, such as in Si photonics. Ge PDs are also therefore more cost effective than equivalent InGaAs PDs.

To utilize Ge PDs, an exemplary system disclosed herein is adapted to overcome the limitation of the relatively high dark current of Ge diodes, typically in the ˜50 uA/cm\hat{ }2 range. The dark-current issue is overcome by use of active imaging having a combination of short capture time and high-power laser pulses.

The utilization of Ge PDs—especially but not limited to ones which are fabricated using CMOS processes—is a much cheaper solution for uncooled SWIR imaging than InGaAs technology. Unlike many prior art imaging systems, active imaging system 100 includes a pulsed illumination source with a short illumination duration (for example, below 1 μS, e.g., 1-1000 μS) and high peak power. This despite the drawbacks of such pulsed light sources (e.g., illumination non-uniformity, more complex readout circuitry which may introduce higher levels of readout noise) and the drawbacks of shorter integration time (e.g., the inability to capture a wide range of distances at a single acquisition cycle). In the following description, several ways are discussed for overcoming such drawbacks to provide effective imaging systems.

Returning now to FIGS. 1C and 1D, these figures illustrate schematically other SWIR imaging systems according to some embodiments and numbered 100′ and 100″. Like system 100, system 100′ comprises an active illumination source 102A and receiver 110. In some embodiments, imaging systems 100, 100′ and 100″ further comprise controller 112 and image processor 114. In some embodiments, processing of the output of receiver 110 may be performed by image processor 114 and additionally or alternatively by an external image processor (not shown). Imaging systems 100′ and 100″ may be variations of imaging system 100. Any component or functionality discussed with respect to system 100 may be implemented in any of systems 100′ and 100″, and vice versa.

Controller 112 is a computing device. In some embodiments, the functions of controller 112 are provided within illumination source 102 and receiver 110, and controller 112 is not required as a separate component. In some embodiments, the control of imaging systems 100′ and 100″ is performed by controller 112, illumination source 102 and receiver 110 acting together. Additionally or alternatively, in some embodiments, control of imaging systems 100′ and 100″ may be performed (or performed supplementally) by an external controller such as a vehicle Electronic Control Unit (ECU) 120 (which may belong to a vehicle in which the imaging system is installed).

Illumination source 102 is configured to emit a light pulse 106 in the infrared (IR) region of the electromagnetic spectrum. More particularly, light pulse 106 is in the SWIR spectral band including wavelengths in a range from approximately 1.3 μm to 3.0 μm.

In some embodiments, such as shown in FIG. 1C, the illumination source (now marked 102A) is an active Q-switch laser (or “actively Q-switched” laser) that includes a gain medium 122, a pump 124, mirrors (not shown) and an active QS element 126A. In some embodiments, QS element 126A is a modulator. Following electronic or optical pumping of the gain medium 122 by pump 124, a light pulse is released by active triggering of QS element 126A.

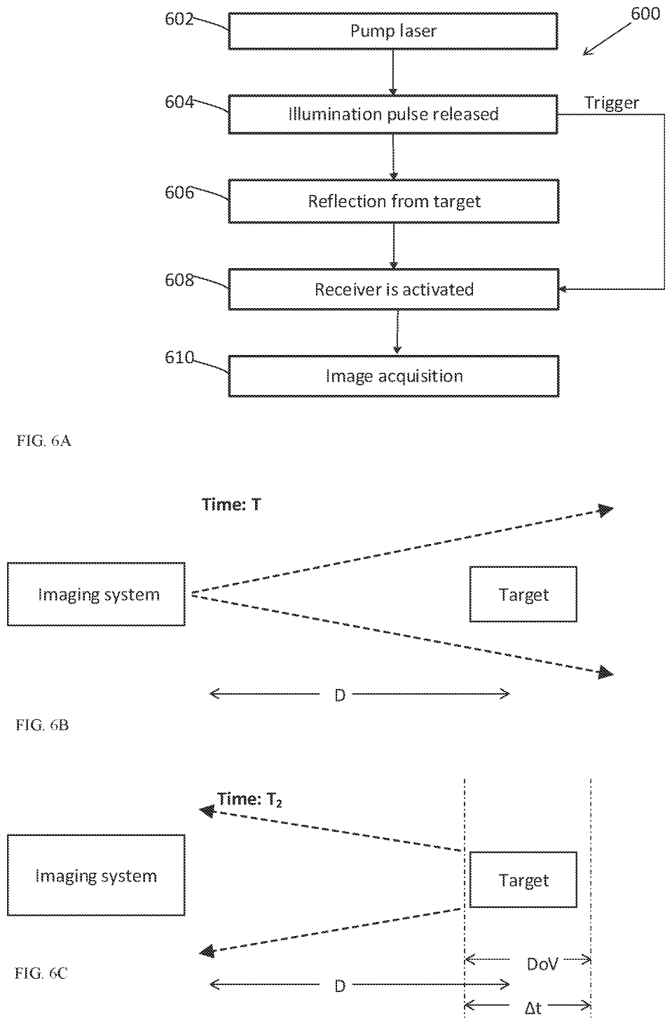

In some embodiments, such as shown in FIG. 1D, illumination source 102P is a P-QS laser including gain medium 122, pump 124, mirrors (not shown) and a SA 126P. SA 126P allows the laser cavity to store light energy (from pumping of gain medium 122 by pump 124) until a saturated level is reached in SA 126P, after which a “passive QS” light pulse is released. To detect the release of the passive QS pulse, a QS pulse PD 128 is coupled to illumination source 102P. In some embodiments, QS pulse PD 128 is a Ge PD. The signal from QS pulse PD 128 is used to trigger the receive process in receiver 110 such that receiver 110 will be activated after a time period suitable for target 104 distance to be imaged. Examples for suitable time periods and for methods utilizing them are described below, e.g. with reference to FIGS. 6B and 6C.

In some embodiments, the laser pulse duration from illumination source 102 is in the range from 100 ps to 1 microsecond. In some embodiments, laser pulse energy is in the range from 10 microjoules to 100 millijoule. In some embodiments, the laser pulse period is of the order of 100 microseconds. In some embodiments, the laser pulse period is in a range from 1 microsecond to 100 milliseconds.

Gain medium 122 is provided in the form of a crystal or alternatively in a ceramic form. Non-limiting examples of materials that can be used for gain medium 122 include: Nd:YAG, Nd:YVO4, Nd:YLF, Nd:Glass, Nd:GdVO4, Nd:GGG, Nd:KGW, Nd:KYW, Nd:YALO, Nd:YAP, Nd:LSB, Nd:S-FAP, Nd:Cr:GSGG, Nd:Cr:YSGG, Nd:YSAG, Nd:Y2O3, Nd:Sc2O3, Er:Glass, Er:YAG, and so forth. In some embodiments, doping levels of the gain medium can be varied based on the need for a specific gain. Non-limiting examples of SAs 126P include: Co2+:MgAl2O4, Co2+:Spinel, Co2+:ZnSe and other cobalt-doped crystals, V3+:YAG, doped glasses, quantum dots, semiconductor SA mirror (SESAM), Cr4+YAG SA and so forth.

Referring to illumination source 102, it is noted that pulsed lasers with sufficient power and sufficiently short pulses are more difficult to attain and more expensive than non-pulsed illumination, especially when eye-safe SWIR radiation in solar absorption based is required.

Receiver 110 may include one or more Ge PDs 118 and receiver optics 116. In some embodiments, receiver 110 includes a 2D array of Ge PDs 118. Receiver 110 is selected to be sensitive to infrared radiation, including at least the wavelengths transmitted by illumination source 102, such that the receiver may form imagery of the illuminated target 104 from reflected radiation 108.

Receiver optics 116 may include one or more optical elements, such as mirrors or lenses that are arranged to collect, concentrate and optionally filter the reflected electromagnetic radiation 228, and focus the electromagnetic radiation onto a focal plane of receiver 110.

Receiver 110 produces electrical signals in response to electromagnetic radiation detected by one or more of Ge PD 118 representative of imagery of the illuminated scene. Signals detected by receiver 110 can be transferred to internal image processor 114 or to an external image processor (not shown) for processing into a SWIR image of the target 104. In some embodiments, receiver 110 is activated multiple times to create “time slices” each covering a specific distance range. In some embodiments, image processor 114 combines these slices to create a single image with greater visual depth such as proposed by Gruber, Tobias, et al. “Gated2depth: Real-time dense LIDAR from gated images.” arXiv preprint arXiv:1902.04997 (2019), which is incorporated herein by reference in its entirety.

In the automotive field, the image of target 104 within the field of view (FOV) of receiver 110 generated by imaging systems 100′ or 100″ may be processed to provide various driver assistance and safety features, such as: forward collision warning (FCW), lane departure warning (LDW), traffic sign recognition (TSR), and the detection of relevant entities such as pedestrians or oncoming vehicles. The generated image may also be displayed to the driver, for example projected on a head-up display (HUD) on the vehicle windshield. Additionally or alternatively imaging systems 100′ or 100″ may interface to a vehicle ECU 120 for providing images or video to enable autonomous driving at low light levels or in poor visibility conditions.

In active imaging scenarios, a light source, e.g. laser, is used in combination with an array of photoreceivers. Since the Ge PD operates in the SWIR band, high power light pulses are feasible without exceeding eye safety regulations. For implementations in automotive scenarios, a typical pulse length is ˜100 ns, although, in some embodiments, longer pulse durations of up to about 1 microsecond are also anticipated. Considering eye safety, a peak pulse power of ˜300 KW is allowable, but this level cannot practically be achieved by current laser diodes. In the present system the high-power pulses are therefore generated by a QS laser. In some embodiments, the laser is a P-QS laser to further reduce costs. In some embodiments, the laser is actively QS.

As used herein the term “target” refers to any of an imaged entity, object, area, or scene. Non-limiting examples of targets in automotive applications include vehicles, pedestrians, physical barriers or other objects.

According to some embodiments, an active imaging system includes: an illumination source for emitting a radiation pulse towards a target resulting in reflected radiation from the target, wherein the illumination source includes a QS laser; and a receiver including one or more Ge PDs for receiving the reflected radiation. In some embodiments, the illumination source operates in the SWIR spectral band.

In some embodiments, the QS laser is an active QS laser. In some embodiments, the QS laser is a P-QS laser. In some embodiments, the P-QS laser includes a SA. In some embodiments, the SA is selected from the group consisting of: Co2+:MgAl2O4, Co2+: Spinel, Co2+:ZnSe and other cobalt-doped crystals, V3+:YAG, doped glasses, quantum dots, semiconductor SA mirror (SESAM), and Cr4+YAG SA.

In some embodiments, the system further includes a QS pulse PD for detecting of a radiation pulse emitted by the P-QS laser. In some embodiments, the receiver is configured to be activated at a time sufficient for the radiation pulse to travel to a target and return to the receiver. In some embodiments, the receiver is activated for an integration time during which the dark current power of the Ge PD does not exceed the kTC noise power of the Ge PD.

In some embodiments, the receiver produces electrical signals in response to the reflected radiation received by the Ge PDs, wherein the electrical signals are representative of imagery of the target illuminated by the radiation pulse. In some embodiments, the electrical signals are processed by one of an internal image processor or an external image processor into an image of the target. In some embodiments, the image of the target is processed to provide one or more of forward collision warning, lane departure warning, traffic sign recognition, and detection of pedestrians or oncoming vehicles.

According to further embodiments, a method for performing active imaging comprises: releasing a light pulse by an illumination source comprising an active QS laser; and after a time sufficient for the light pulse to travel to a target and return to the QS laser, activating a receiver comprising one or more Ge PDs for a limited time period for receiving a reflected light pulse reflected from the target. In some embodiments, the illumination source operates in the SWIR spectral band. In some embodiments, the limited time period is equivalent to an integration time during which a dark current power of the Ge PD does not exceed a kTC noise power of the Ge PD.

In some embodiments, the receiver produces electrical signals in response to the reflected light pulse received by the Ge PDs wherein the electrical signals are representative of imagery of the target illuminated by the light pulse. In some embodiments, the electrical signals are processed by one of an internal image processor or an external image processor into an image of the target. In some embodiments, the image of the target is processed to provide one or more of forward collision warning, lane departure warning, traffic sign recognition, and detection of pedestrians or oncoming vehicles.

According to further embodiments, a method for performing active imaging comprises: pumping a P-QS laser comprising a SA to cause release of a light pulse when the SA is saturated; detecting the release of the light pulse by a QS pulse PD; and after a time sufficient for the light pulse to travel to a target and return to the QS laser based on the detected light pulse release, activating a receiver comprising one or more Ge PDs for a limited time period for receiving the reflected light pulse. In some embodiments, the QS laser operates in the shortwave infrared (SWIR) spectral band.

In some embodiments, the SA is selected from the group consisting of Co2+:MgAl2O4, Co2+:Spinel, Co2+:ZnSe, other cobalt-doped crystals, V3+:YAG, doped glasses, quantum dots, semiconductor SA mirror (SESAM) and Cr4+YAG SA. In some embodiments, the limited time period is equivalent to an integration time during which the dark current power of the Ge PD does not exceed the kTC noise power of the Ge PD.

In some embodiments, the receiver produces electrical signals in response to the reflected light pulse received by the Ge PDs wherein the electrical signals are representative of imagery of the target illuminated by the light pulse. In some embodiments, the electrical signals are processed by one of an internal image processor or an external image processor into an image of the target. In some embodiments, the image of the target is processed to provide one or more of forward collision warning, lane departure warning, traffic sign recognition, and detection of pedestrians or oncoming vehicles.

Exemplary embodiments relate to a system and method for high SNR active SWIR imaging using Ge based PDs. In some embodiments, the imaging system is a gated imaging system. In some embodiments, the pulsed illumination source is an active or P-QS laser.

FIG. 2 is a schematic block diagram illustrating another SWIR imaging system disclosed herein and numbered 200. System 200 comprises an illumination module (source) 202, an analysis module 208, an imaging receiver (e.g. a camera) 210 and a controller 212 for controlling the imaging receiver and the illumination module and for providing synchronization therebetween. Analysis module 208 may optionally include an image processor such as, e.g., image processor 114. Illumination source 202 includes optics 224 for illuminating a field of view and including the target scene and at least two illuminators with two different wavelengths, for example a first illuminator 226 with a first wavelength WL1 and a second illuminator 228 with a second wavelength WL2. It is noted that the two or more illuminators 226 and 228 may be implemented as one or more light sources that emit light in the aforementioned two different wavelengths (or more), wherein the separation into distinct wavelengths (or wider spectral bands) is achieved using suitable spectral filters. Imaging receiver 210 includes optics 216, a PFA 220 and a SWIR FPA 222. FPA 222 may include a plurality of photodiodes such as (but not limited to) Ge PDs 118. System 200 may be used to detect hazardous materials in a target scene such as target 104, for example ice or water on a road.

It is determined that the polarization of the reflected light can be detected by PFAs that are embedded in the FPA, integrated with the FPA, or attached to the FPA. In some embodiments, the micro-polarizers are part of the FPA. In some embodiments, the micro-polarizers are a separate part of a system that includes the FPA and are attachable to the FPA. In general, such micro-polarizers are said to be “associated with” the FPA or “associated with” elements of the FPA (such as Ge PDs). Examples for such micro-polarizers are shown in FIGS. 3A and 3B.

FIG. 3A shows various types of color filter arrays (CFAs) and PFAs: in (a) a CFA, in (b) and (c) two types of PFAs, and in (d) and (e) two types of combined PFAs and CFAs.

Array 300 is an exemplary CFA with two different wavelength filters, 302 and 304, placed in an alternating pattern in two dimensions.

Array 310 is an exemplary PFA with two different and perpendicular polarizations: filter 312 transmits polarization horizontal to the ground (if the vehicle is level) while filter 314 blocks this horizontal polarization, transmitting the polarization vertical to the ground.

Array 320 is an exemplary PFA with four different types of polarization filters in an alternating pattern. Filter 322 transmits polarization parallel to the ground. Filter 324 transmits polarization at 45 degrees to the ground and filter 326 transmits polarization perpendicular to the ground. Filter 328 transmits circular polarization, right handedly oriented for photons perpendicularly incident on the filter array.

Array 330 is an exemplary color and polarization filter array. Filter 332 transmits light in a first wavelength band employed for road hazard detection and polarized parallel to the ground. Filter 334 transmits light in a second wavelength band used to detect road hazards and polarized vertical to the ground. Filter 336 transmits light in the first wavelength band and polarized vertical to the ground. Filter 338 transmits light in the second wavelength band and polarized horizontal to the ground.

Array 340 is another exemplary color and polarization filter array. Filter 342 transmits light in the first wavelength band used to detect road hazards. Filter 344 transmits light in the second wavelength band used to detect road hazards. Filter 346 transmits light polarized horizontal to the ground, if the vehicle is level. Filter 348 transmits light polarized vertical to the ground.

This arrangement provides polarimetric imaging functionality. Such polarization filters can be implemented in a known way, see e.g. Takashi Tokuda et al. “Polarization-analyzing CMOS image sensor with monolithically embedded polarizer for microchemistry systems”, IEEE Transactions on Biomedical Circuits and Systems, Vol. 3, No. 5, October 2009, p. 259.

In some embodiments, a SWIR FPA such as FPA 222 is based on Ge on Si technology. The FPA is integrated with a PFA that gives rise to in situ polarization imaging without the need for additional optical elements, using a single camera and without the need to take consecutive images at different polarizations. As an example, we can place the polarization filter directly on the sensor chip, where each pixel in the filter matches in its dimensions the pixel of the sensor. Alternatively, we can implement micro polarizers during the manufacturing of the sensor. This is shown schematically in FIG. 3B.

FIG. 3B shows an example of the structure of a single photo-detecting (PD) element 350 with an integrated micro-polarizer in a Ge-on-Si FPA disclosed herein. PD 350 comprises an “absorbing” Ge layer 352 (typically few μm thick) grown or bonded to a Si layer 354 also a few μm thick. A micro-polarizer (or micropolarizer layer) 356 is manufactured by known deposition and lithographic techniques on top of the Si layer. It typically includes a periodic II) array of metal (e.g. aluminum, copper or any other metal compatible with CMOS technology), with a periodicity at the subwavelength scale and thickness ranging from tens of nanometers to hundreds of nanometers. Optionally, an anti-reflection layer 358 is applied on top of the micro-polarizer. Alternatively, the order can be reversed, i.e. first applying the anti-reflection coating directly on the silicon and then applying the micro-polarizer. Optionally, a spacer layer 360, typically a few μm thick, followed by a microlens 362 are applied on top of the anti-reflection/micro-polarizer layers. The spacer layer is designed to confine the light focused by the microlens in absorbing Ge layer 352.

In some examples, micro-polarizers may have arrangements as shown in 370 and 380. Micro-polarizer arrangement 370 includes four pixels 370a-d with two different orientations (370a and 370e being one orientation and 370b and 370d being another orientation), giving rise to the transmission of vertical and horizontal polarization component. Micro-polarizes arrangement 380 includes four pixels 380a-d with four different orientations 380a, 380b, 380c and 380d, giving rise to the transmission of vertical, +45 degrees, horizontal and −45 degrees polarized light.

The combination of both spectral and polarization information creates a multi dimensional image of the scene, and the diversity of these two independent detection methods increases the detection probability.

Optionally, the images from the polarization filter arrays can be preprocessed via demosaicing algorithms, see e.g. Malvar, Henrique S., Li-Wei He, and Ross Cutler. “High-quality linear interpolation for demosaicing of Bayer-patterned color images”, 2004 IEEE International Conference on Acoustics, Speech, and Signal Processing, vol. 3, pp. iii-485. IEEE, 2004.

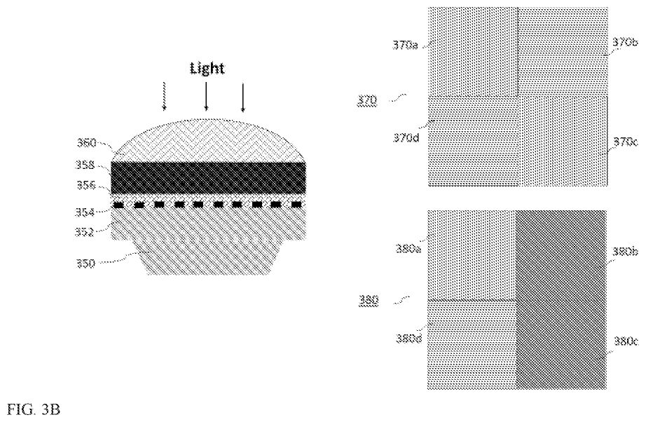

FIG. 4 shows schematically an embodiment of a passive system for detection of black ice on roads. In this figure, an option for the realization the passive road hazard detection system is sketched roughly and schematically. A vehicle 400 comprises a sensing system 402 comprising a PFA 220 and a SWIR FPA 222 disclosed herein as well as other elements of system 200 except illumination sources. Vehicle 400 moves on a road and faces a road hazard 408, for example black ice. As this system is passive, the illumination is provided by ambient light 404. A reflection 406 from road hazard 408 in the direction of vehicle 400 is detected by sensing system 402.

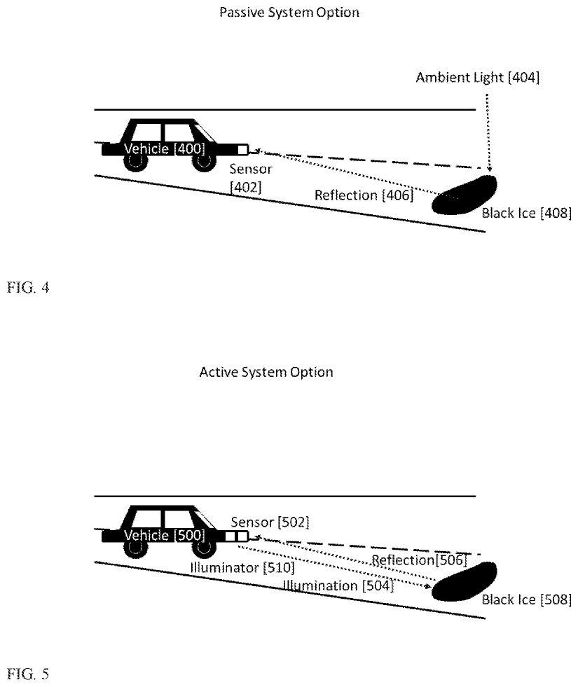

FIG. 5 shows schematically an embodiment of an active system for detection of black ice on roads. A vehicle 500 comprises a sensing system 502 like system 200, i.e. includes illumination sources. Vehicle 500 moves on a road and faces a road hazard 508, for example black ice. As this system is active, the illumination is provided by one or more illumination sources 510 that illuminates the road with illumination 504. A reflection 506 from road hazard 508 in the direction of vehicle 500 is detected by sensing system 502. Note that while only one illumination source 510 is shown, numeral 510 is meant to also represent at least two different illumination sources like first illuminator 226 with a first wavelength WL1 and second illuminator 228 with a second wavelength WL2 in system 200. Accordingly, illumination 504 may represent two illuminations with two wavelengths WL1 and WL2, and reflection 506 may represent two reflections with two wavelengths WL1 and WL2.

The goal of detecting hazards on the road can be achieved with computer vision methods, be they based on Neural Networks, classical machine learning, or using hand crafted analytical features. The analysis can potentially make use of information from additional focal plane arrays, for example a visible (i.e. RGB) camera. FIG. 6 shows an example of such data fusion. This can be achieved using known algorithms, e.g. Dong, Limin, Qingxiang Yang, Haiyong Wu, Huachao Xiao, and Mingliang Xu. “High quality multi-spectral and panchromatic image fusion technologies based on Curvelet transform.” Neurocomputing 159 (2015): 268-274.

For example, the images can be analyzed using a Neural Network (Convolutional), where the two-dimensional filters are learned by the network. Optionally the multi-spectral images will be analyzed conjointly by a spatio-spectral Convolutional Neural Network (CNN).

The multidimensionality of the data is thus harnessed with the similarly multidimensional filter of the CNN, allowing the network to learn both the spatial and spectral features of the data. Polarization information, either raw, or preprocessed, can be added and analyzed as additional channels to the data cube. That is, the network does not work spatially across each image and the go to the next image in a different wavelength, but instead takes all the dimension into account, learning the properties of the multispectral/multipolarization image cube.

Alternatively, the polarization images can be analyzed with fusion methods, handcrafted or otherwise, rendering a two-dimensional image where the grayscale is monotonously dependent on the likelihood of the pixel belonging to black ice. Using a threshold, either hard or adaptive, this image is then translated to a binary image. The binary image can be put through a connected component algorithm, potentially after morphological operators, and the outcome is a binary image which defines the localization of the road hazard in the scene. This can be done for example as described in Nakauchi, Shigeki et al., “Selection of optimal combinations of band-pass filters for ice detection by hyperspectral imaging.” Optics Express 20, no. 2 (2012): 986-1000.

If the polarization and multi-spectral data is analyzed with different methodologies, the resulting two binary classification maps can be combined with voting techniques, handcrafted fusion, or a further classifier, whether it be classical or a Neural Network.

Reference is now made to FIGS. 6A, 6B and 6C that show, respectively, a flowchart and schematic drawings of a method of operation of an active SWIR imaging system according to some exemplary embodiments. Process 600 shown in FIG. 6A is based on system 100′ as described with reference to FIG. 1C. In step 602, pump 124 of illumination source 102A is activated to pump gain medium 122. In step 604, active QS element 126A releases a light pulse in the direction of a target that is at a distance of D. In step 606, at Time=T, the light pulse strikes the target and generates reflected radiation back towards system 100′ and receiver 110. In step 608, after waiting a time=T2, receiver 110 is activated to receive the reflected radiation. The return propagation delay T2 consists of the flight time of the pulse from illumination source 102A to the target plus the flight time of the optical signal reflected from the target. T2 is therefore known for a target at a distance “D” from the illumination source 102A and receiver 110. The activation period of receiver 110 Δt is determined based on the required depth of view (DoV). The DoV is given by 2 DoV=c*Δt where c is the speed of light. A typical Δt of 100 ns provides a depth of view of 15 meters. In step 610, the reflected radiation is received by receiver 110 for a period of Δt. The received data from receiver 110 is processed by image processor 114 (or an external image processor) to generate a received image. Process 600 can be repeated N times in each frame, where a frame is defined as the data set transferred from receiver 110 to image processor 114 (or to an external image processor). In some embodiments, N is between 1 and 10,000.

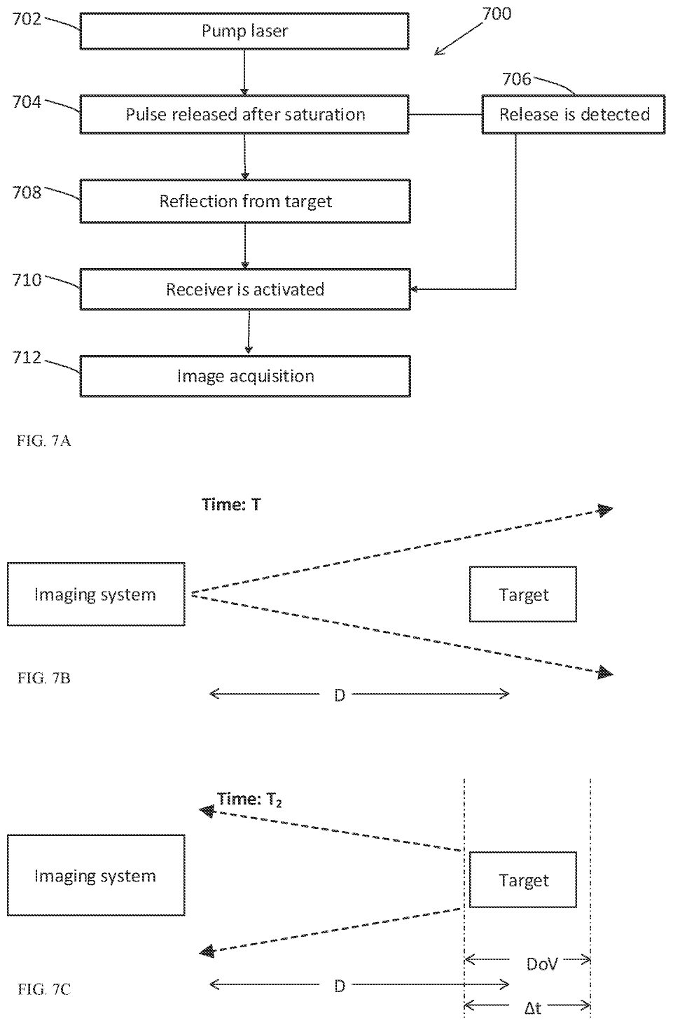

Reference is now made to FIGS. 7A, 7B and 7C that show, respectively, a flowchart and schematic drawings of an exemplary method of operation of an active SWIR imaging system according to some embodiments. A process 700 shown in FIG. 7A is based on system 100″ as described with reference to FIG. 1D. In step 702, pump 124 of illumination source 102P is activated to pump gain medium 122 and to saturate SA 126P. In step 704, after reaching a saturation level, SA 126P releases a light pulse in the direction of a target at a distance of D. In step 706, QS pulse PD 128 detects the released light pulse. In step 708, at Time=T, the light pulse strikes the target and generates reflected radiation back towards system 100″ and receiver 110. In step 710, after waiting a time=T2 following the detection of a released light pulse by QS pulse PD 128, receiver 110 is activated to receive the reflected radiation. The return propagation delay T2 comprises the flight time of the pulse from illumination source 102P to the target plus the flight time of the optical signal reflected from the target. T2 is therefore known for target at a distance “D” from the illumination source 102P and receiver 110. The activation period of Δt is determined based on the required depth of view (DoV). In step 712, the reflected radiation is received by receiver 110 for a period of Δt. The received data from receiver 110 is processed by image processor 114 (or by an external image processor) to generate a received image. Process 700 can be repeated N times in each frame. In some embodiments, N is between 1 and 10,000.

Referring to all of imaging systems 100, 100′, 100″ or 200, it is noted that any one of those imaging systems may include readout circuitry for reading out, after the integration time, an accumulation of charge collected by each of the Ge PDs, to provide the detection signal for the respective PD. That it, unlike LIDARs or other depth sensors, the reading out process may be executed after the concussion of the integration time and therefore after the signal from a wide range of distances as irreversibly summed.

Referring to all of imaging systems 100, 100′, 100″ or 200, optionally receiver 110 outputs a set of detection signals representative of the charge accumulated by each of the plurality of Ge PDs over the integration time, wherein the set of detection signals is representative of imagery of the target as illuminated by at least one SWIR radiation pulse.

Referring to all of imaging systems 100, 100′, 100″ or 200, the imaging system may optionally at least one diffractive optics element (DOE) operative to improve illumination uniformity of light of the pulsed illumination source before the emission of light towards the target. As aforementioned, a high peak power pulsed light source 102 may issue an insufficiently uniform illumination distribution over different parts of the FOV. The DOE (not illustrated) may improve uniformity of the illumination to generate high quality images of the FOV. It is noted that equivalent illumination uniformity is usually not required in LIDAR systems and other depth sensors, which may therefore not include DOE elements for reasons of cost, system complexity, system volume, and so on. In LIDAR systems, for example, as long as the entire FOV receive sufficient illumination (above a threshold which allows detection of target at a minimal required distance), it does not matter if some areas in the FOV receive substantially more illumination density than other parts of the FOV. The DOE of system 100, if implemented, may be used for example for reducing speckle effects. It is noted that imaging systems 100, 100′, 100″ or 200″ may also include other types of optics for directing light from light source 102 to the FOV, such as lenses, mirrors, prisms, waveguides, etc.

Referring to all of imaging systems 100, 100′, 100″ or 200, controller 112 (or 212) may optionally be operative to activate receiver 110 (or 210) to sequentially acquire a series of gated images, each representative of the detection signals of the different Ge PDs at a different distance range, and an image processor operative to combine the series of image into a single two dimensional image. For example, a first image may acquire light between 0-50 m, a second image may acquire light between 50-100 m and a third image may acquire light between 100-125 m from the imaging sensor, and image processor 114 may combine the plurality of 2D images to a single 2D images. This way, each distance range is captured with accumulated dark current noise that is still lesser than the readout noise introduced by the readout circuitry, in the expense of using more light pulses and more computation. The color value for each pixel of the final image (e.g., grayscale value) may be determined as a function of the respective pixels in the gated images (e.g., a maximum of all values, or a weighted average).

Referring to all of imaging systems 100, 100′, 100″ or 200, the imaging system may be an uncooled Ge-based SWIR imaging system, operative to detect a 1 m×1 m target with a SWIR reflectivity (at the relevant spectral range) of 20% at a distance of more than 50 m.

Referring to all of imaging systems 100, 100′, 100″ or 200, pulsed illumination source 102 may be a QS laser operative to emit eye safe laser pulses having pulse energy between 10 millijoule and 100 millijoule. While not necessarily so, the illumination wavelength may be selected to match a solar absorption band (e.g., the illumination wavelength may be between 1.3 μm and 1.4 μm.

Referring to all of imaging systems 100, 100′, 100″ or 200, the output signal by each Ge PD used for image generation may be representative of a single scalar for each PD. Referring to all of imaging systems 100, 100′, 100″ or 200, each PD may output an accumulated signal that is representative of a wide range of distances. For example, some, most, or all of the Ge PDs of receiver 110 (or 210) may output detection signals which are representative each of light reflected to the respective PD from 20 m, from 40 m and from 60 m.

Further distinguishing feature of imaging systems 100, 100′, 100″ or 200, over many known art systems is that the pulsed illumination is not used to freeze fast motion of objects in the field (unlike photography flash illumination, for example) and is used the same for static scenes. Yet another distinguishing feature of imaging systems 100, 100′, 100″ or 200, over many known art systems is that the gating of the image is not used primarily to avoid internal noise in the system, in comparison to external noise, which is a nuisance for some known art (e.g., sunlight).

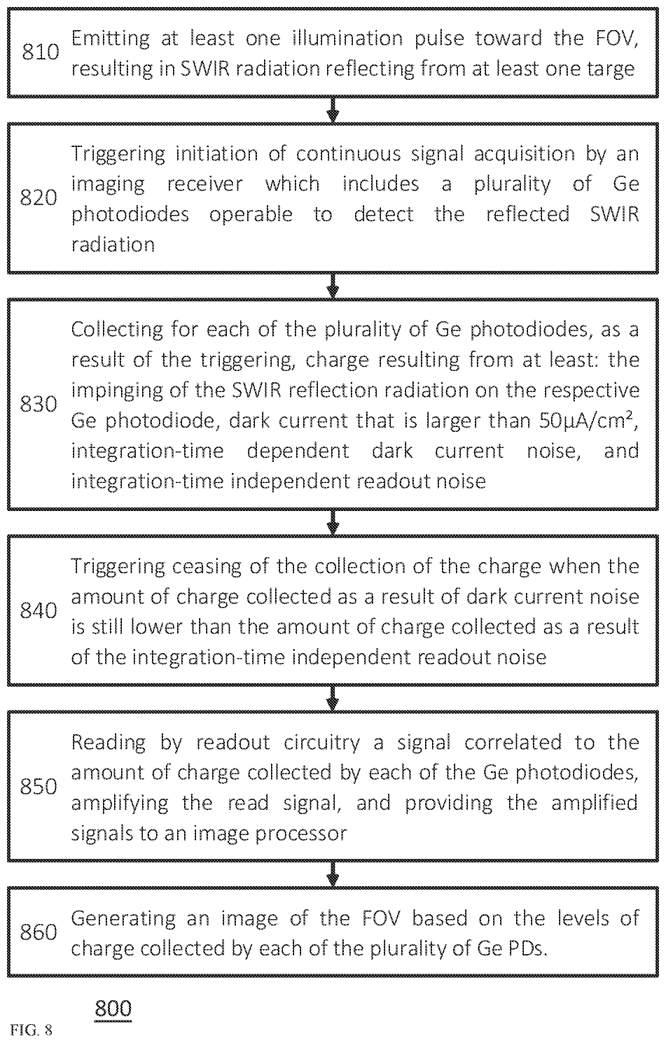

FIG. 8 is a flowchart illustrating a method 800 for generating SWIR images of objects in a FOV of an EO system, in accordance with examples of the presently disclosed subject matter. Referring to the examples set forth with respect to the previous drawings, method 800 may be executed by any one of imaging systems 100, 100′, 100″ or 200.

Method 800 starts with a step (or “stage”) 810 of emitting at least one illumination pulse toward the FOV, resulting in SWIR radiation reflecting from at least one target. Hereinafter, “step” and “stage” are used interchangeably. Optionally, the one or more pulses may be high peak power pulse. Utilization of multiple illumination pulses may be required, for example, to achieve an overall higher level of illumination when compared to a single pulse. Referring to the examples of the accompanying drawings, step 810 may optionally be carried out by controller 112 (or 212).

A step 820 includes triggering initiation of continuous signal acquisition by an imaging receiver that includes a plurality of Ge PDs (in the sense discussed above with respect to receiver 110 or 210) which is operative to detect the reflected SWIR radiation. The continuous signal acquisition of step 820 means that the charge is collected continuously and irreversibly (i.e., it is impossible to learn what level of charge was collected in any intermediate time), and not in small increments. The triggering of step 820 may be executed before step 810 (for example, if the detection array requires a ramp up time), concurrently with step 810, or after step 810 concluded (e.g., to start detecting at a nonzero distance from the system). Referring to the examples of the accompanying drawings, step 820 may optionally be carried out by controller 112 (or 212).

A step 830 starts after the triggering of step 820 and includes collecting for each of the plurality of Ge PDs, as a result of the triggering, charge resulting from at least the impinging of the SWIR reflection radiation on the respective Ge PD, dark current that is larger than 50 μA/cm², integration-time dependent dark current noise, and integration-time independent readout noise. Referring to the examples of the accompanying drawings, step 830 may optionally be carried out by receiver 110 (or 210).

A step 840 includes triggering ceasing of the collection of the charge when the amount of charge collected as a result of dark current noise is still lower than the amount of charge collected as a result of the integration-time independent readout noise. The integration time is the duration of step 830 until the ceasing of step 840. Referring to the examples of the accompanying drawings, step 840 may optionally be carried out by controller 112 (or 212).

A step 860 is executed after step 840 is concluded, and it includes generating an image of the FOV based on the levels of charge collected by each of the plurality of Ge PDs. As aforementioned with respect to imaging systems 100, 100′, 100″ or 200, the image generated in step 860 is a 2D image with no depth information. Referring to the examples of the accompanying drawings, step 860 may optionally be carried out by imaging processor 114.

Optionally, the ceasing of the collection as a result of step 840 may be followed by optional step 850 reading by readout circuitry a signal correlated to the amount of charge collected by each of the Ge PDs, amplifying the read signal, and providing the amplified signals (optionally after further processing) to an image processor that carries out the generation of the image as step 860. Referring to the examples of the accompanying drawings, step 850 may optionally be carried out by the readout circuitry. It is noted that step 850 is optional because other suitable methods of reading out the detection results from the Ge PSs may be implemented.

Optionally, the signal output by each out of multiple Ge PDs is a scalar indicative of amount of light reflected from 20 m, light reflected from 40 m and light reflected from 60 m.

Optionally, the generating of step 860 may include generating the image based on a scalar value read for each of the plurality of Ge PDs. Optionally, the emitting of step 810 may include increasing illumination uniformity of pulsed laser illumination by passing the pulsed laser illumination (by one or more lasers) through at least one diffractive optics element (DOE), and emitting the detracted light to the FOV. Optionally, the dark current is greater than 50 picoampere per Ge PD. Optionally, the Ge PDs are Si—Ge PDs, each including both Silicon and Ge. Optionally, the emitting is carried out by at least one active QS laser. Optionally, the emitting is carried out by at least one P-QS laser. Optionally, the collecting is executed when the receiver is operating at a temperature higher than 30° C., and processing the image of the FOV to detect a plurality of vehicles and a plurality of pedestrians at a plurality of ranges between 50 m and 150 m. optionally, the emitting includes emitting a plurality of the illumination pulses having pulse energy between 10 millijoule and 100 millijoule into an unprotected eye of a person at a distance of less than 1 m without damaging the eye.

As aforementioned with respect to active imaging systems 100, 100′, 100″ or 200, several gated images may be combined to a single image. Optionally, method 800 may include repeating multiple times the sequence of emitting, triggering, collecting and ceasing; triggering the acquisition at a different time from the emitting of light at every sequence. At each sequence method 800 may include reading from the receiver a detection value for each of the Ge PDs corresponding to a different distance range that is wider than 2 m (e.g., 2.1 m, 5 m, 10 m, 25 m, 50 m, 100 m). The generating of the image in step 860 in such a case includes generating a single two-dimensional image based on the detection values read from the different Ge PDs at the different sequences. It is noted that since only several images are taken, the gated images are not sparse (i.e. in all or most of them, there are detection values for many of the pixels). It is also noted that the gated images may have overlapping distance ranges. For example, a first image may represent the distances range 0-60 m, a second image may represent the distances range 50-100 m, and a third image may represent the distances range 90-120 m.

In the description above, numerous specific details were set forth to provide a thorough understanding of the disclosure. However, it will be understood by those skilled in the art that the present disclosure may be practiced without these specific details. In other instances, well-known methods, procedures, and components have not been described in detail so as not to obscure the present disclosure.

The terms “computer”, “processor”, “image processor”, “controller”, “control module”, and “analysis module” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit, etc.), any other electronic computing device, and or any combination thereof.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages or steps illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

Any reference in the specification to a system should be applied mutatis mutandis to a method that may be executed by the system and should be applied mutatis mutandis to a non-transitory computer readable medium that stores instructions that may be executed by the system.

It should be understood that where the claims or specification refer to “a” or “an” element, such reference is not to be construed as there being only one of that element.

While this disclosure describes a limited number of embodiments, it will be appreciated that many variations, modifications and other applications of such embodiments may be made. The disclosure is to be understood as not limited by the specific embodiments described herein, but only by the scope of the appended claims.

What is claimed is:

1. A system, comprising:
an imaging receiver operating in the short wave infrared range (SWIR) and including a focal plane array (FPA) and a polarization filter array (PFA), the imaging receiver operative to acquire SWIR image data; and
an analysis module for analyzing the SWIR image data for detection of hazardous media on a road, wherein the hazardous media includes ice.

2. The system of claim 1, wherein the FPA includes germanium-on-silicon (Ge—Si) photodetectors (PDs).

3. The system of claim 2, wherein the PFA includes an arrangement of micro-polarizers.

4. The system of claim 3, wherein each Ge—Si PD is associated with a micro-polarizer.

5. The system of claim 3, wherein the arrangement of micro-polarizers includes two micro-polarizers.

6. The system of claim 4, wherein the arrangement of micro-polarizers includes four micro-polarizers.

7. The system of claim 4, wherein the associated micro-polarizer is integrated with the PD.

8. The system of claim 1, further comprising a first illumination source for illuminating a target scene in a first SWIR range, and wherein the SWIR image data includes data carried by radiation reflected in the first SWIR range.

9. The system, of claim 8, wherein the FPA includes germanium-on-silicon (Ge—Si) photodetectors (PDs).

10. The system of claim 8, wherein the PFA includes an arrangement of micro-polarizers.

11. The system of claim 10, wherein each Ge—Si PD is associated with a micro-polarizer.

12. The system of claim 11, wherein the arrangement of micro-polarizers includes two micro-polarizers of the array.

13. The system of claim 11, wherein the arrangement of micro-polarizers includes four micro-polarizers.

14. The system of claim 11, wherein the associated micro-polarizer is integrated with the PD.

15. The system of claim 8, further comprising a second illumination source for illuminating a target scene in a second SWIR range, and wherein the SWIR image data includes data carried by radiation reflected in the second SWIR range.

16. A method, comprising:
acquiring short wave infrared range (SWIR) image data using an imaging receiver that includes a focal plane array (FPA) and a polarization filter array (PFA); and
analyzing the SWIR image data for detection of hazardous media on a road, wherein the hazardous media includes ice.

17. The method of claim 16, wherein the FPA includes germanium-on-silicon (Ge—Si) photodetectors (PDs).

18. The method of claim 17, wherein the PFA includes an arrangement of micro-polarizers.

19. The method of claim 16, further comprising illuminating a target scene in a first SWIR range, wherein the SWIR image data includes data carried by radiation reflected in the first SWIR range.

20. The method of claim 19, further comprising illuminating the target scene in a second SWIR range using a second illumination source, wherein the SWIR image data includes data carried by radiation reflected in the second SWIR range.
